(19) United States
(12) Patent Application Publication
(10) Pub. No.: US 2017/0238522 A1
(43) Pub. Date: Aug. 24, 2017

(54) INSECT TRAP ASSEMBLY

(71) Applicant: SYNERGY SEMIOCHEMICALS CORPORATION, Burnaby (CA)

(72) Inventor: David Wakarchuk, Delta (CA)

(21) Appl. No.: 15/437,433

(22) Filed: Feb. 20, 2017

Related U.S. Application Data
(60) Provisional application No. 62/297,689, filed on Feb. 19, 2016.

(51) Int. Cl. A01M 1/10

(52) U.S. Cl. CPC A01M 1/103; A01M 1/106

(57) ABSTRACT

An insect trap assembly comprises a collection cup having a circumferential side wall, a bottom and an open flared top. The open flared top has a flared surface and a flared end outside diameter. The assembly further comprises at least one funnel for guiding any insects into the collection cup. The funnel has a top opening inside diameter and a bottom opening inside diameter. The flared end outside diameter of the collection cup is smaller than the funnel's top opening inside diameter, but it is greater than the funnel's bottom opening inside diameter. This allows the collection cup to be positioned within the funnel in a capture arrangement. The insect trap assembly may also be provided with a plurality of spoked panel support members so as to allow the insect trap assembly to support a plurality of panels in combination with the at least one funnel.

### CROSS REFERENCE TO RELATED APPLICATION

This application is a regular application of U.S. Provisional Patent Application Ser. No. 62/297,689 filed Feb. 19, 2016 and entitled, “INSECT TRAP”, the entirety of which is incorporated herein by reference.

### FIELD OF THE INVENTION

Embodiments provided herein relate to methods and apparatus for capturing insects, more particularly an insect trap assembly to efficiently capture varieties of wood boring, bark and ambrosia beetles, as well as their predators and parasites.

### BACKGROUND OF THE INVENTION

Entomologists study insects' habitats and how insects evolve. They also develop ways to control harmful insects, research and control insect-borne diseases, and discover and study new species of insects. In many cases, the most effective way to study insects is to trap them in their natural environment. There are many different methods and apparatus used to trap insects, however, scientists are always looking to more easily and efficiently trap insects for study.

A multiple funnel trap such as that disclosed in U.S. Pat. No. 4,471,563 to Lindgren, the entirety of which is incorporated herein by reference, has proven to be very versatile for trapping a variety of insects. While the trap is often used for trapping ambrosia, bark, and wood boring beetles, the trap is also able to capture a wide variety moths, wasps, siricidae, flies and other flying insects. Trap features that have made the Lindgren trap popular include: modular, collapsible design with variable length (e.g. 4, 8 and 12 funnel size), robust performance under windy field conditions and the ability to capture large numbers of insects when used in combination with high potency semiochemical lures.

Currently, however, many insect trap assemblies that follow the design set out in U.S. Pat. No. 4,471,563 to Lindgren need to have two dedicated funnel molds; a first mold for a bottom funnel that contains a means of connecting to insect collection cup or container (such as having a threaded end connection on the bottom of the funnel) and a second mold for regular funnel (without cup mounting capability). The bottom funnel in a Lindgren style trap may also requires tooling which allows the collection cup to be mounted to the funnel. In addition to the bottom funnel mold being complex, the current bottom funnel product has a 1.5 cm wide horizontal ridge inside the funnel which often interrupts insects' slide into the collection cup, thereby providing significant opportunities for insects to escape.

The structure connecting the funnels on a Lindgren style multiple funnel trap is known as a “leg”. After years of field use, original traps occasionally suffered broken “legs” leading to the modular “leg”, where funnels were molded separately from the legs. This allows an easy field repair for broken funnel connections. However the “leg” mating in the keyhole structures of the Lindgren style funnel require significant force to install. Replacing a single broken “leg” in the field is relatively easy; however, assembling 10's or hundreds of 12 unit multiple funnel traps during manufacturing is exceptionally fatiguing, even when using a specialized tool.

Collection cups or containers are used at the bottom of the Lindgren style trap and are connected to the lower funnel. It is important for the collection cups to be removable from the hanging trap so scientists may collect the insects in the collection cup and replace the cup with a new one for further sampling. New trap users sometimes have difficulty mounting the insect collection cup to the bottom of the funnel. Often times, there are small plastic tabs for locking the collection cup to the funnel, that when misaligned, can shear off when installing the collection cups. Bottom funnels need a means to fasten a collection cup that has specialized mounting hardware. U.S. Pat. No. 4,471,563 to Lindgren teaches that the collection container may be rotated so as to detach it from the insect trap assembly. However, it has been found that in windy conditions an insect trap assembly will swing and bang against the support rod, thereby slow loosening (or unthreading) the collection cup from the assembly. As such, it is desirable to have a means of attaching the collection cup to the trap assembly so that the cup will not detach during windy conditions.

There is commonly two methods of trapping insects, the first is known as “wet” trapping where the collection cup contains insect killing fluid like soapy water. The second method is known as “dry” trapping wherein rain water drains through perforations in the collecting cup and no killing fluid is used. Currently, when scientists are dry trapping, metal screens are mounted in the collection cups over drain holes. Collection cups with bungs or having plastic mesh molded into the insect collection cup are expensive features when alternating the trap from “wet” trapping to “dry” trapping.

Prior art insect traps may also utilize a plurality of panels instead of funnels. These panel traps are often referred to as intercept traps or cross vane traps. Cross vane traps may provide a larger visual tree silhouette than standard funnel traps and, in certain applications, capture more target beetles than standard funnel traps. Four-panel cross vane traps, wherein the panels are oriented in a cross or x configuration, are commercially available and are used in many of the same applications where multifunnel traps are used. However, these cross vane traps also tend to act like kites in high winds. The four-panels of cross vane traps often need very robust trap stands and frequently must be staked to keep them stable in windy locations.

Use of a larger funnel at the base of the trap has been investigated by various researchers. For larger wood boring beetles this adaptation generally gives higher captures. This is probably the result of better captures of beetles that bounce off the upper trap surface while in flight; the larger bottom funnel provides additional insect collection area. Very large traps, while very effective at capturing large wood boring beetles, are not only expensive to manufacture but also very cumbersome to deploy in the field, and would require yet another plastic mold for a third (larger) funnel design.

Coloured sticky coated traps have been used to capture Emerald Ash borer an invasive species in eastern North America. While these traps have been useful, they are cumbersome to deploy since the sticky surface is on the outside of the trap. Ultimately sticky traps are not selective and trap unwanted debris and non-target insects. Compared to reusable trap designs, sticky traps are expensive as they are single season use at best. Moreover it is difficult to remove insects from the adhesive for detailed examination.

All prior art traps are known in only a single configuration. That is, funnel traps are only funnel traps, and panel intercept traps are only intercept traps. There is a need in the industry for an improved insect trap design providing the availability to not only, create multi-configured insect trap designs in capturing insects, but also to address the disadvantages of the Lindgren style funnel trap and be more economical to manufacture.

### SUMMARY OF THE INVENTION

In one aspect, an insect trap assembly comprises a collection cup having a circumferential side wall, a bottom and an open flared top. The open flared top has a flared surface and a flared end outside diameter. The assembly further comprises at least one funnel for guiding any insects into the collection cup. The funnel has a top opening inside diameter and a bottom opening inside diameter. The flared end outside diameter of the collection cup is smaller than the funnel's top opening inside diameter, but it is greater than the funnel's bottom opening inside diameter. This allows the collection cup to be positioned within the funnel in a capture arrangement.

In another aspect, the insect trap assembly may also be provided with a plurality of spoked panel support members, to allow the insect trap assembly to support a plurality of panels in combination with the at least one funnel.

### BRIEF DESCRIPTION OF THE DRAWINGS

Referring to the drawings, several aspects of the present invention are illustrated by way of example, and not by way of limitation, in detail in the figures, wherein:

FIG. 1 is a perspective view of a first embodiment of an insect trap assembly according to the present invention, the assembly comprising plurality of identical frusto-conical funnel members arranged one above the other and communicating with a collection cup;

FIG. 2A is a perspective view of an embodiment of a frusto-conical funnel used in the embodiment of the insect trap assembly of FIG. 1;

FIG. 2B is a side view of the funnel of FIG. 2A;

FIG. 2C is a top view of the funnel of FIG. 2A;

FIG. 3A is a perspective view of an embodiment of a collection cup used in the embodiment of the insect trap assembly of FIG. 1;

FIG. 3B is a side view of the collection cup of FIG. 3A;

FIG. 3C is a top view of the collection cup of FIG. 3A;

FIG. 3D is a sectioned perspective view of the collection cup of FIG. 3A;

FIG. 4A is a sectioned perspective view of the embodiment of the collection cup of FIG. 3A engaged with the embodiment of the funnel of FIG. 2A in a captured arrangement;

FIGS. 4B-4D are side views of the embodiment of the collection cup of FIG. 3A engaging to a captured arrangement with the embodiment of the funnel of FIG. 2A

FIG. 5 is a perspective view of an embodiment of a predator exclusion device for an insect trap assembly of the present invention;

FIG. 6 is a perspective view of the embodiment of the predator exclusion device of FIG. 5 mounted within the embodiment of the insect trap assembly of FIG. 1;

FIG. 7A is a perspective view of an embodiment of a canopy used in the embodiment of the insect trap assembly of FIG. 1;

FIG. 7B is a bottom view of the canopy of FIG. 7A;

FIG. 7C is a top view of the canopy of FIG. 7A;

FIG. 8A is a top view of an embodiment of a short tensile connector member used in the embodiment of the insect trap assembly of FIG. 1;

FIG. 8B is a perspective view of the short tensile connector member of FIG. 8A;

FIG. 9A is a perspective view of an embodiment of a long tensile connector member used in the embodiment of the insect trap assembly of FIG. 1;

FIG. 9B is a top view of the long tensile connector member of FIG. 9A;

FIG. 9C is a side view of the long tensile connector member of FIG. 9A;

FIG. 10 is a perspective view of the insect trap assembly of embodiment provided in FIG. 1, shown in a collapsed arrangement;

FIG. 11 is a sectioned perspective view of the insect trap assembly of FIG. 10;

FIG. 12 is a perspective view of a second embodiment of an insect trap assembly according to the present invention, the assembly comprising plurality of identical frusto-conical funnel members arranged one above the other, communicating with a collection cup and further comprising a funnel collar extension on the bottom most funnel;

FIG. 13A is a perspective view of the embodiment of the funnel collar used in the embodiment of the insect trap assembly of FIG. 12;

FIG. 13B is a side view of the funnel collar of FIG. 13A;

FIG. 13C is a top view of the funnel collar of FIG. 13B;

FIG. 14 is a side view of the insect trap assembly of FIG. 12;

FIG. 15A is a perspective view of a third embodiment of an insect trap assembly according to the present invention, the assembly comprising plurality of identical frusto-conical funnel members arranged one above the other, communicating with a collection cup and further comprising a plurality of panel members above the top most funnel;

FIG. 15B is a sectioned perspective view of the insect trap assembly of FIG. 15A;

FIG. 16A is a perspective view of an embodiment of a spoked panel support member used in the embodiment of the insect trap assembly of FIG. 15A;

FIG. 16B is a top view of the spoked panel support member of FIG. 16A;

FIG. 16C is a side view of the spoked panel support member of FIG. 16A;

FIG. 17 is a side perspective view of the insect trap assembly of FIG. 15A; and

FIG. 18 is a perspective view of a fourth embodiment of an insect trap assembly according to the present invention, the assembly comprising plurality of identical frusto-conical funnel members arranged one above the other, communicating with a collection cup and further comprising a plurality of panel members and a funnel collar extension on the funnel.

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

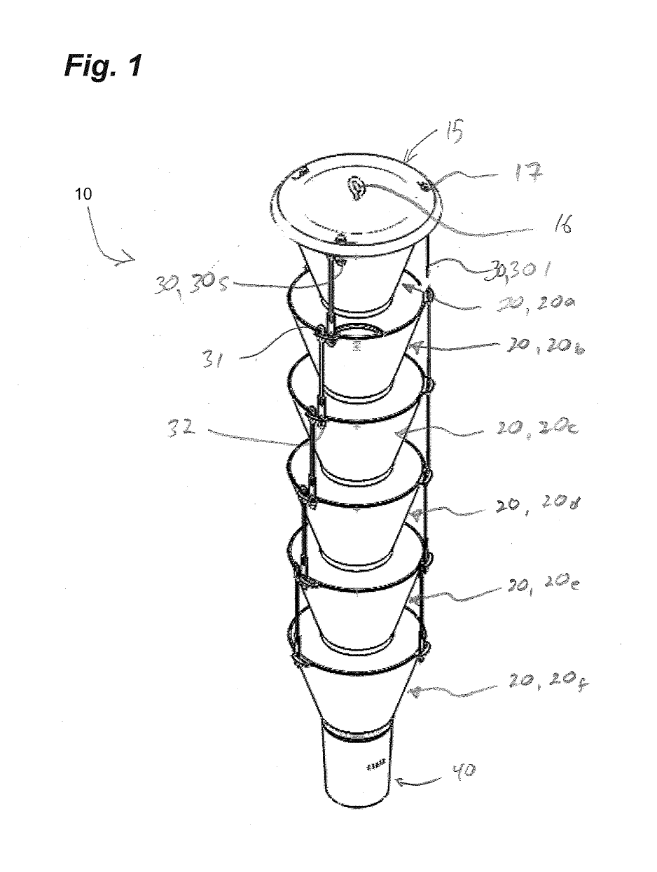

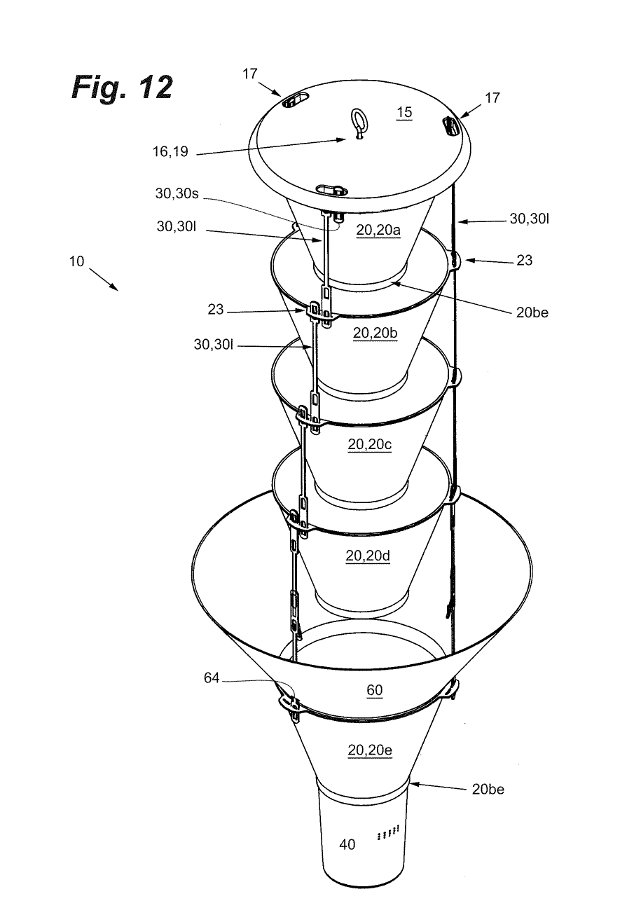

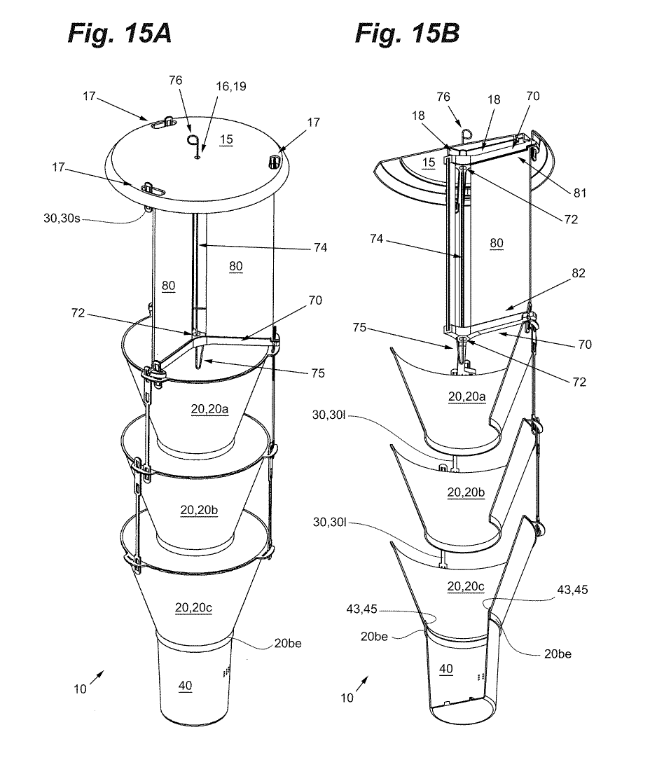

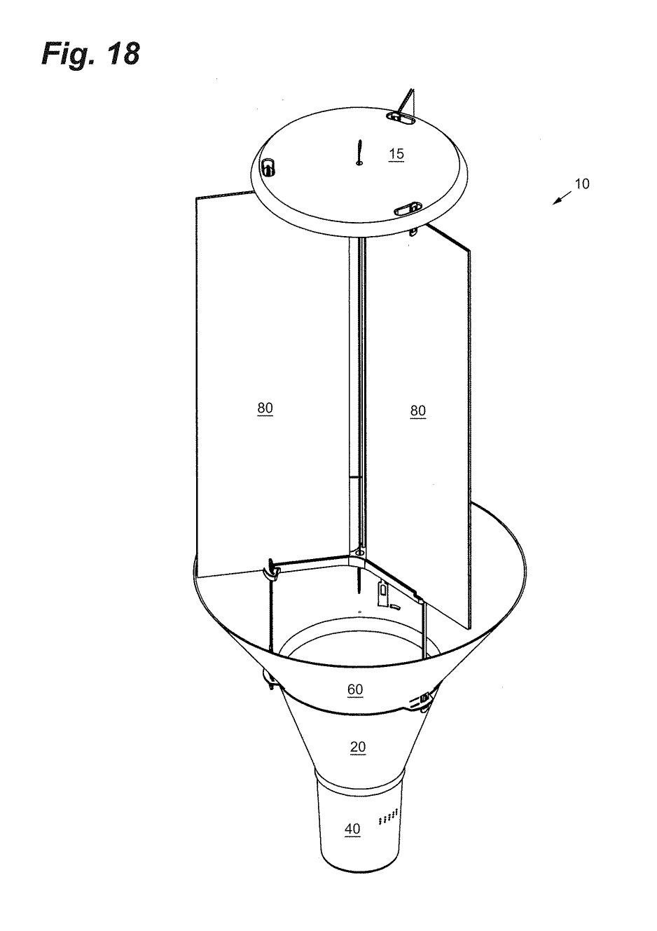

With reference to FIGS. 1, 12, 15A and 18, various embodiments of an insect trap assembly 10 are provided. Embodiments provided herein generally comprise a canopy 15, at least one funnel 20, a plurality of tensile connectors 30 to connect various components of the assembly 10 together, and a collection cup or container 40. Certain embodiments of the insect trap assembly 10 may comprise a plurality of funnels, wherein the funnel are arranged as taught in U.S. Pat. No. 4,471,563 to Lindgren, i.e. with frusto-conical funnels 20a-20e arranged one above the other and communicating with a collection container 40 secured to a lowermost funnel 20e (e.g. as shown in FIGS. 1, and 12). Other embodiments of the assembly 10 may comprise a single funnel (e.g. as shown in FIG. 18). Still other embodiments of the insect trap assembly may further comprise panels 80 in addition to funnels 20 (e.g. as shown in FIGS. 15A and 18). The various components of the assembly 10 will be discussed in further detail below.

### Canopy

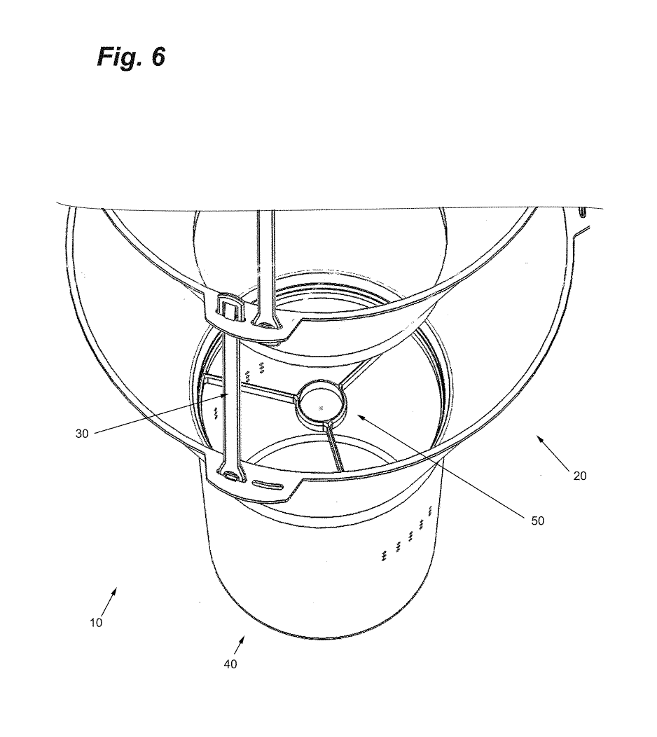

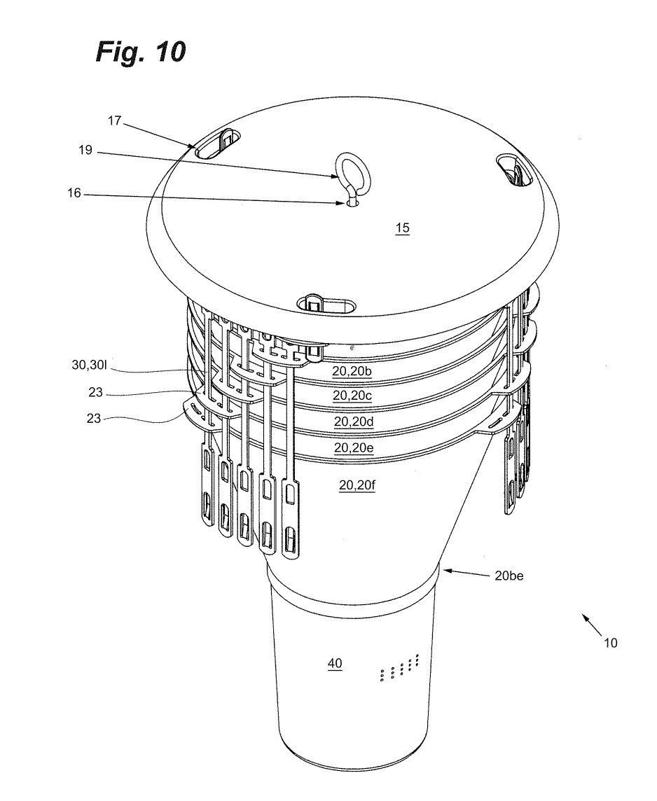

Having reference to FIGS. 1 and 7A-7C, an embodiment of a canopy or lid 15 is provided for use with the insect trap assembly 10. In the present embodiment, the canopy 15 is a circular disk shape, but those skilled in the art would recognize that the canopy 15 may be various shapes. The canopy 15 provides a connection point 16 for hanging the insect trap assembly 10 from a support such as a tree. The canopy 15 also acts to provide a cover for the top funnel 20a for preventing or reducing rain water and debris from collecting in the insect trap assembly 10 and the collection cup 40. The connection point 16 may accept a hook or loop 19 (e.g. FIG. 10) or alternatively be a hole therethrough for accepting a tensile connector member 74 (e.g. FIG. 15). The canopy 15 comprises a plurality of slots 17 located around the perimeter of the canopy 15 for accepting and securing tensile connector members 30 therein. Preferably, the canopy 15 further comprises reinforcing members 18 spanning between each of the plurality of slots 17 and the connection point 16 (see FIGS. 7B and 15B), to allow the canopy 15 to transfer a greater amount of force (e.g. from the connector members 30) to the connection point 16. Reinforcing members 18 may be simply thickened sections of the canopy's body.

In the present embodiment, a short tensile connector member 30s may used to releasably connect the canopy 15 to the top-most funnel 20a (e.g. FIG. 1). Further, in the present embodiment, the colour of the canopy is preferred to be black, or alternatively a dark colour. It has been found by those skilled in the art that a white coloured canopy is less desirable for unwanted insects, such as wasps, to be present about the insect trap or build nests thereon.

### Funnel

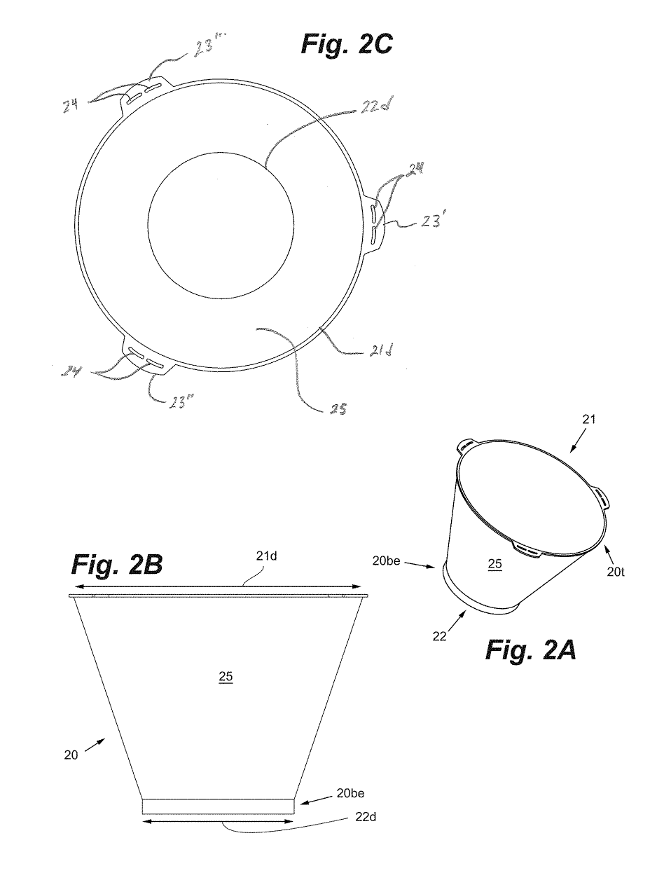

With reference to the Figures, and especially FIGS. 2A-2C, the funnel 20 preferably comprises a circumferential wall 25, a top end 20t, a bottom end 20be, a top opening 21 for accepting insects therethrough, and a bottom opening 22 for allowing insects to pass therethrough. The funnel 20 is preferably a frusto-conical member. The top opening 21 has a top opening inside diameter 21d, and the bottom opening has a bottom opening inside diameter 22d. If the funnel is a frusto-conical member, then the bottom opening inside diameter 22d will be smaller than the top opening inside diameter 21d, when the funnels are oriented generally as shown in the Figures. The top opening 21 comprises a plurality of tabs 23 protruding away from and substantially perpendicular the central axis of the funnel 20. The tabs 23 have a slot therethrough 24 for accepting and securing the tensile connector member 30 therein.

The funnels 20 are preferably identical and may be positioned in a series comprising any number of funnels 20a, 20b, 20c, 20d, 20e to suit the requirements of the user. The top end 20t of the first funnel 20a is axially aligned and connected to the underside of the canopy 15. A second funnel 20b may be axially aligned and connected to the top funnel 20a. The second funnel 20b is spaced from the top funnel 20a such that the top end 20t of the second funnel 20b is near the same plane as the bottom end 20b of the top funnel 20a. The spacing of the funnels 20 in this manner allow for target insects to contact any of the funnels 20a, 20b, 20c, 20d, 20e and fall into the top opening 21 of the funnel 20 therebelow. Those skilled in the art understand that the spacing of the funnels 20a, 20b, 20c, 20d, 20e may vary, depending on the application of the user. The present embodiments only utilize one funnel type, there is no special ‘bottom’ funnel as is commonly used in the prior art. Prior art bottom funnels provide a ridge inside the bottom funnel which allowed for some target insects to escape the trap thereby making it less efficient. By using one funnel type, without such a ridge, the insect trapping efficiency of the present assembly 10 is increased.

### Collection Cup

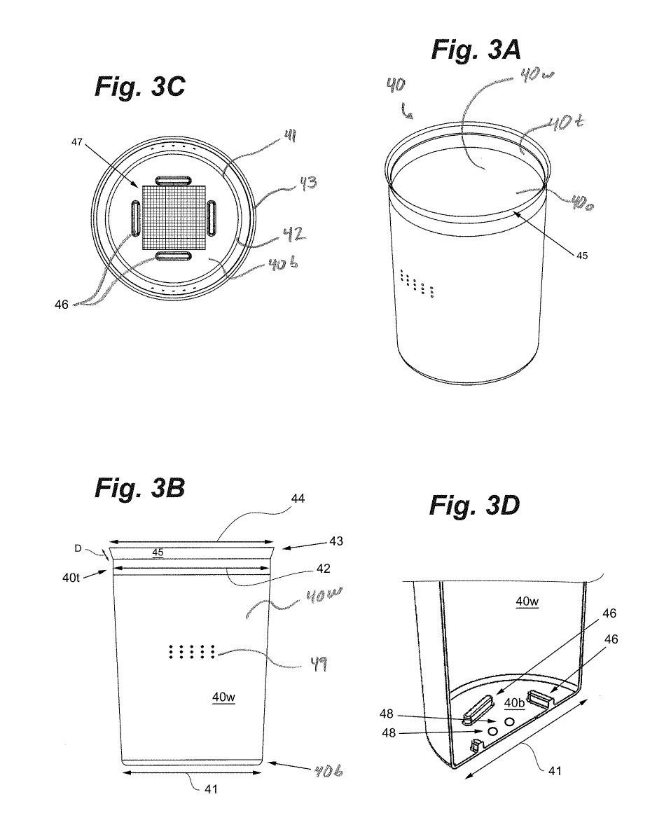

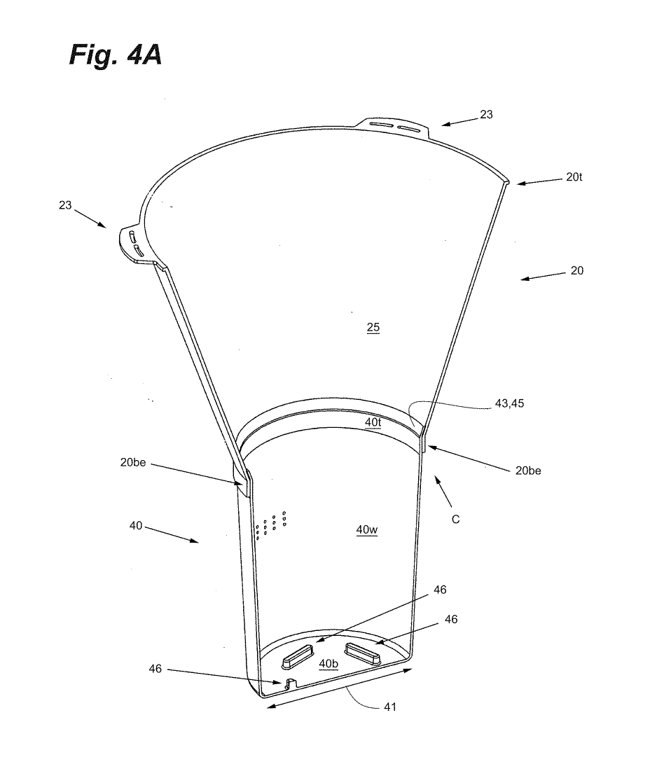

With reference to FIGS. 3a to 4d, a collection cup 40 is provided for collecting insects that fall from making contact with the insect trap assembly 10. Different embodiments are provided depending upon the user conducting dry trapping or wet trapping. As noted above, in dry trapping the collection cup 40 is to remain free of fluid including collecting rain water. In wet trapping, the collection cup 40 is filled with an insect drowning fluid, typically salt water, with a little detergent or propylene glycol (RV anti-freeze). The propylene glycol is used in hot climates and has a lower evaporation rate than pure water.

In a preferred embodiment, the collection cup 40 comprises a circumferential side wall 40w, a bottom 40b having a bottom diameter 41, a top end 40t forming an opening 40o and having a top end diameter 42, the opening 40o suitable for accepting insects therethrough an collect on the bottom 40b. The bottom diameter 41 is preferably slightly less/smaller than the top end diameter 42, providing for stacking of the collection cups when not in use. The bottom diameter 41 is preferably slightly less/smaller than the inside diameter 22d of the funnel's bottom opening 22, thereby allowing the bottom 40b of the cup 40 to pass through both the top opening 21 and bottom opening 22 of the funnel.

A flared or flanged end 43 is provided on the collection cup 40 and is spaced a distance D from the top end 40t, creating a flared surface 45 therebetween and having a flared end outside diameter 44. The flared end outside diameter 44 is greater than the top end diameter 42 and greater the inside diameter 22d of the funnel's bottom opening 22, thereby causing the cup 40 to be captured by the bottom end 20be of the funnel 20, in a captured arrangement C, when cup 40 is inserted into funnels' top end 20t; see FIGS. 4A-4D. Preferably, the outside of the flared surface 45 is dimensioned such that it can substantially mate in an abutting relationship with the inside surface of the circumferential wall 25 of a funnel 20, when cup is inserted through the top end 20t of the funnel 20 and placed in the captured arrangement C (see FIG. 4A).

Advantageously, cup 40 is maintained in the captured arrangement C during operation by gravity when the insect trap assembly 10 is hung from the connection point 16. More advantageously, cup 40 can be captured by any funnel 20 and only a single funnel mold will need to be made to manufacture/produce the assembly 10. Even more advantageously, cup 40 is not threaded onto the bottom end of a funnel 20 and, therefore, is not liable to be unthreaded, such as during windy conditions. Still even more advantageously, neither the cup 40 nor the funnel 20 require small plastic tabs for locking the collection cup to the funnel (as is common in the prior art traps); and therefore there are no small plastic tabs to misaligned or shear off, as is common with the prior art traps.

Furthermore, the collection cup 40 may comprise holes 48 located in the bottom 40b of the collection cup 40 for allowing water to escape therethrough during a dry trap formation (e.g. FIG. 3D). A screen 47 may be provided for positioning over the holes 48 at the bottom 40b of the collection cup 40 (e.g. FIG. 3C). The screen 47 is selected to retain the target insects (which can be as small as 1 mm long), but allow rain water to drain freely. The screen 47 assists in preventing the holes 48 from getting plugged from the trapped insects therein.

Preferably, screen alignment tabs 46 are provided at a desired location on the bottom 40b for securing the screen 47 therebetween. The screen alignment tabs 46 are preferably protrusions from the bottom 40b of the collection cup 40, up towards the top end 40t of the collection cup 40. The screen alignment tabs 46 may be formed in any pattern necessary to provide the support for the screen 47 to assist in preventing the screen 47 from moving within the collection cup 40 when it is move from wind or other such environmental elements. In the present embodiment, the screen alignment tabs 46 are positioned such as to secure the screen 47 in the shape of a square or rectangle. Again, one of skill in the art would recognize that the screen 47 may be any number of shapes in order to fit on the bottom 40b of the collection cup 40. However, a square or rectangular screen is typically cheaper to manufacture than a round or circular screen. Advantageously, by providing screen alignment tabs 46 in a pattern to secure a square or rectangular screen, a collection cup 40 having a generally cylindrical shape can be manufactured, while a square or rectangular screen 47 can then be secured over drainage holes 48 (see FIG. 3C-3D).

In another embodiment, and during wet trapping formation, a plurality of circumferential sidewall holes 49 are provided and spaced from the bottom end 40b for defining the maximum allowable fluid level in the cup. The plurality of circumferential sidewall holes 49 prevent the collection cup 40 from overflowing with liquid during wet trapping operations. Advantageously, the present embodiments require only one cup mold and all cups may have circumferential sidewall holes 49. The collection cups 40 may be any colour, however, those skilled in the art recognize that the collection cups are typically white (opaque) to reduce insects' normal phototactic escape responses.

### Tensile Connector Members

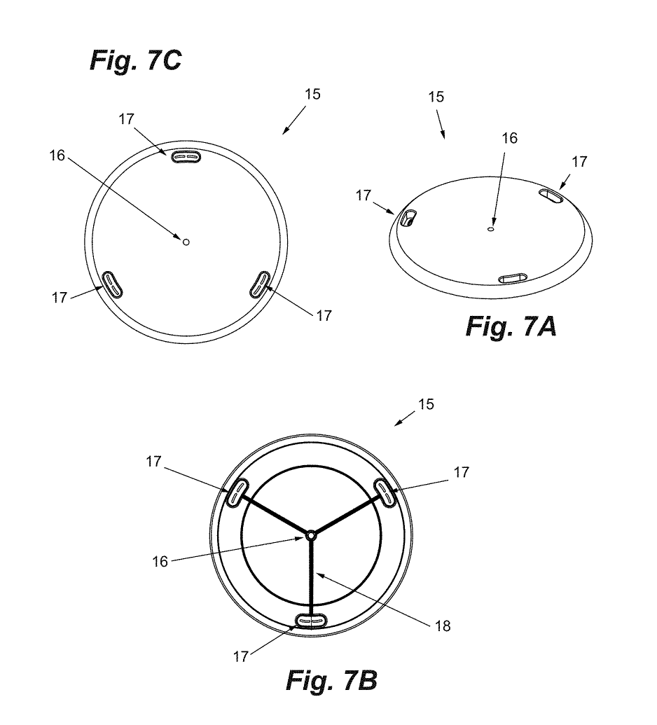

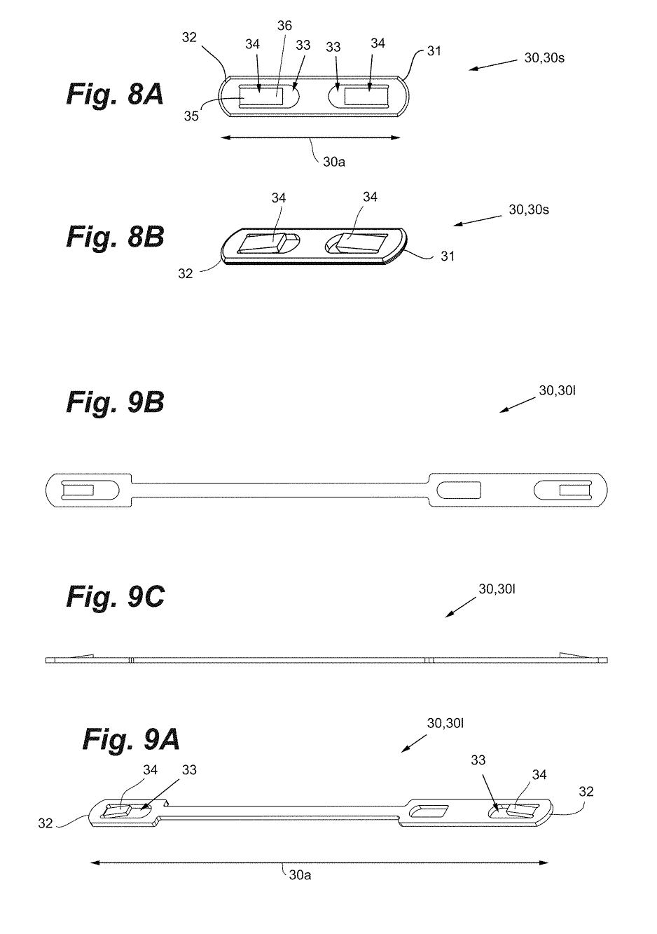

Having reference to FIGS. 8A-9C various embodiments of tensile connector members 30 are provided for connecting the funnels 20 and canopy 15 together in series to construct the insect trap assembly 10. As noted earlier, in certain embodiments the frusto-conical funnels 20a-20e are arranged one above the other and communicate with a collection container 40 secured to a lowermost funnel 20e (e.g. as shown in FIGS. 1, and 12).

The tensile connector members 30 are preferably flexible and made from malleable materials such as forms of plastic, rubber or fabric. The tensile connector members 30 comprise a first end 31 and a second end 32 and having a longitudinal connection 30a therebetween. The first end 31 and the second end 32 comprise a planar surface having a hole 33 therethrough. A flexible tab 34 is provided having a first end 35 and a second end 36. The first end 35 of the flexible tab 34 is connected to the inside of the hole 33 nearest the first end 31 of the tensile connector member 30. The flexible tab 34 protrudes along the longitudinal axis 30a of the tensile connector member 30 and is smaller than the size of the hole 33. The second end 36 of the flexible tab 34 is biased away from the plane of the tensile connector member 30 for providing a means to engage the slot 24 of the funnel 20 or the slot 17 of the canopy 15.

FIGS. 8A-8B illustrate an embodiment of the short tensile connector member 30s while FIGS. 9A-9C provide an embodiment of the long tensile connector members 30l. The short tensile connector members 30s are preferably used for releasably connecting the canopy 15 to the funnel 20 at the top of the series of funnels 20a,20b,20c. The long tensile connector members 30l are preferably used for releasably connecting the series of funnels 20a,20b,20c together.

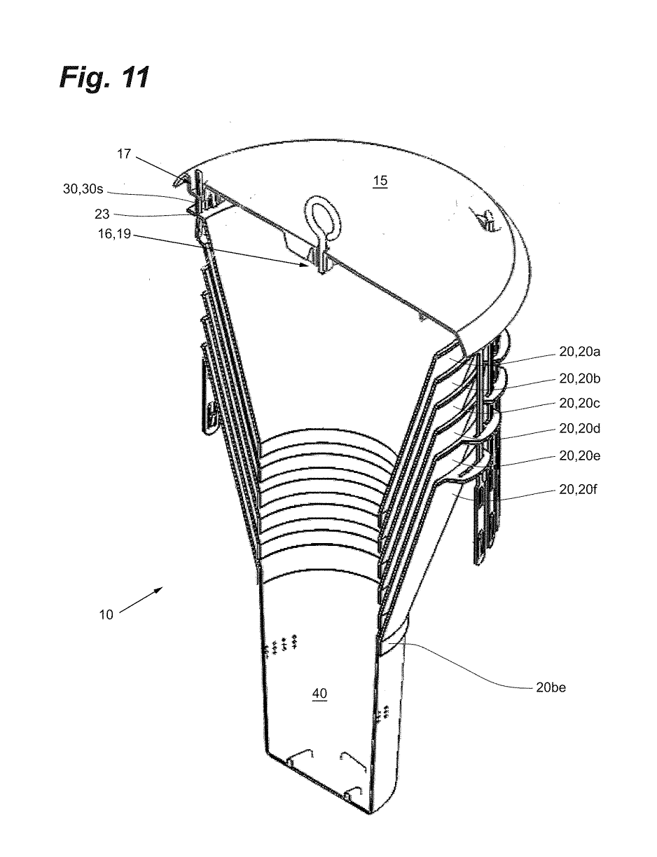

Having reference to FIGS. 10 and 11, embodiments of an insect trap assembly 10 may be provided in a compact or shipping form. The long tensile connector members 30 may push through the slot 24 of the multiple funnels 20a, 20b, 20c. The funnels may be nested within one another in order to make the insect trap assembly more versatile as a whole. Upon assembly, one of skill in the art would recognize that the multiple funnels 20a, 20b, 20c must be assembled in such a way wherein the multiple tabs 23 are offset by one slot 24 in a step formation for the entire series of funnels 20. To extend the insect trap assembly 10, the canopy 15 and the collection cup 40 are extended along the longitudinal axis of the funnels 20 in opposing directions and the flexible tabs 34 of the tensile connector members 30 will engage the tabs 23 of the funnels 20 supporting the funnel 30 there below.

### Predator Exclusion Apparatus

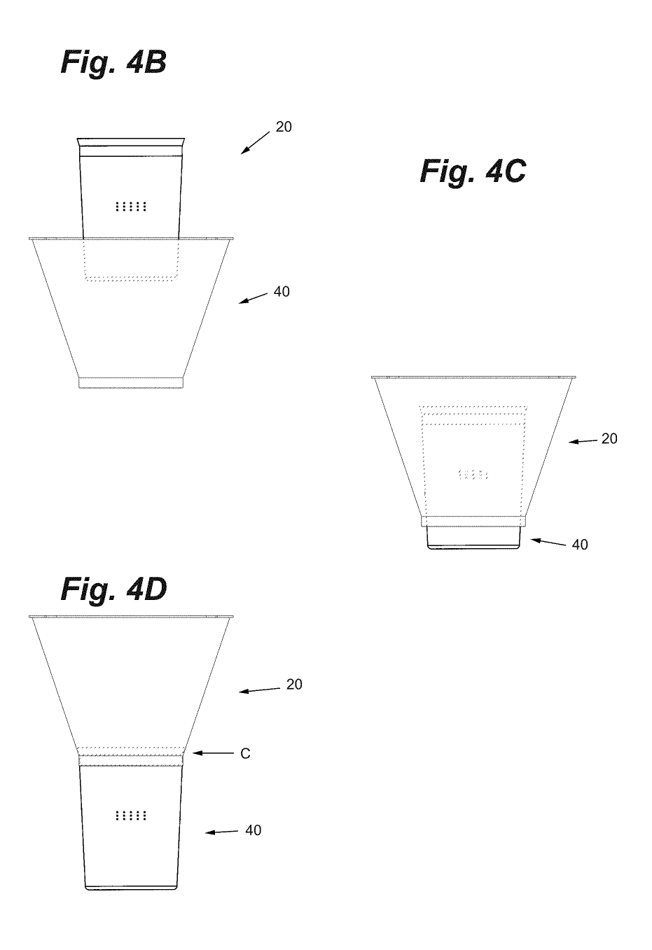

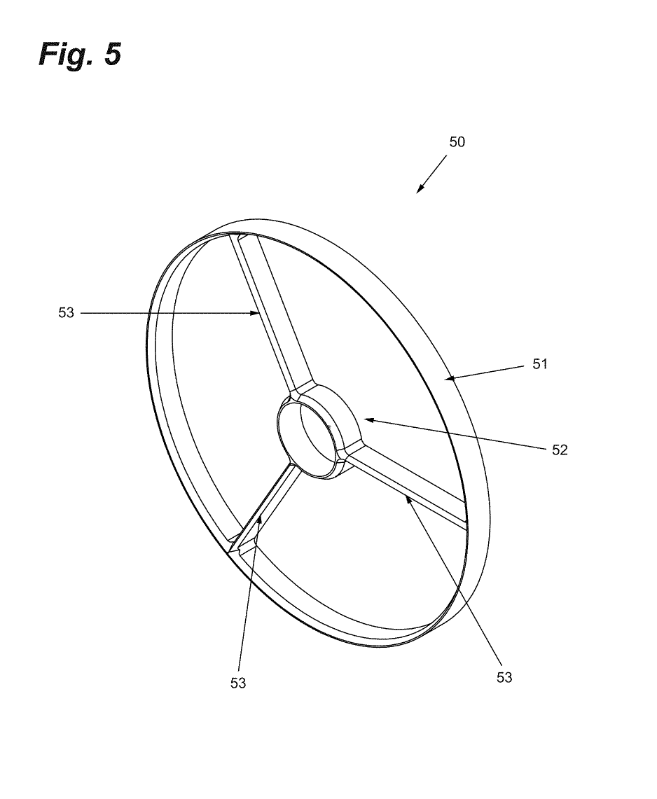

FIGS. 5 and 6 provide an embodiment of a predator exclusion apparatus or predator screen 50 to be used within the insect trap assembly 10 for deterring insect predators such as bats and birds from entering the insect trap assembly 10 and gaining access to the collection cup 40 to feed off the target insects therein. The predator exclusion apparatus 50 comprises a hallow disc 51 having an outer diameter 51d, and inner circle 52 having an inner circle diameter 52d. The outer diameter 51d being greater than the inner circle diameter 52d. The inner circle 52 being supported in the same plane as the hallow disc 51 by two or more spokes 53 extending from the hallow disc 51 to the inner circle 52. The outer diameter 51d sized for engaging the inside of the flared surface 45 of the collection cup 40 (FIG. 6). The spokes 53 function to keep out predators from the cup 40 and those skilled in the art recognize that the number and position of the spokes 53 may depend on the nature of the predators as well as the target insects.

### Funnel Collar

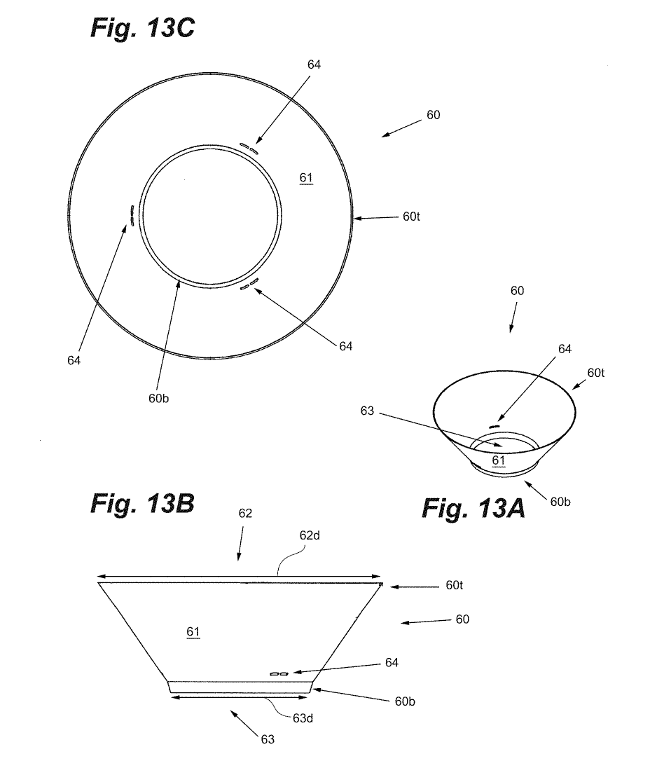

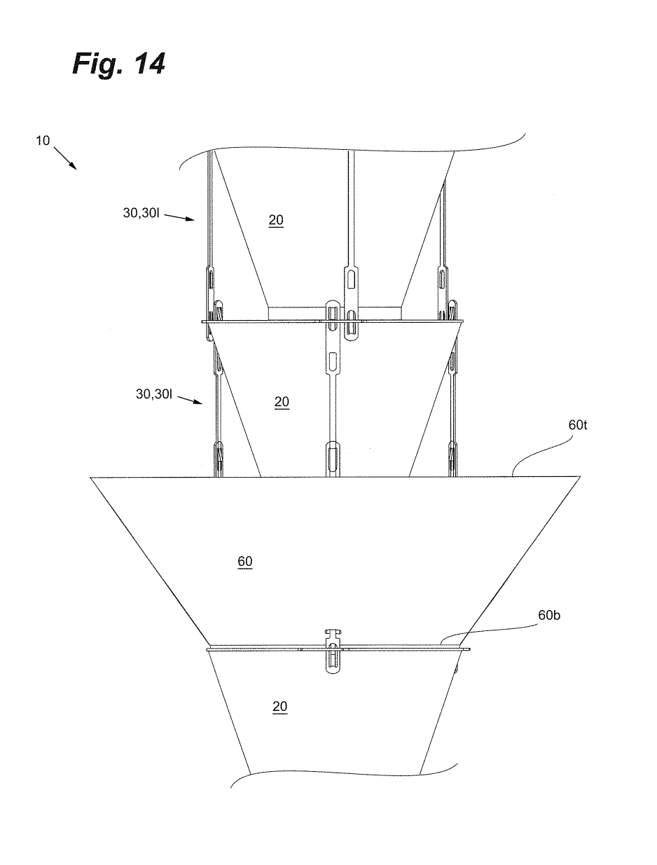

In an alternative embodiment, the assembly 10 further comprises a funnel collar 60 on the bottom-most funnel 20. Having reference to FIGS. 12-14, the funnel collar 60 is a frusto-conical member comprising a circumferential wall 61, a top end 60t, a bottom end 60b, a top opening 62 for accepting insects therethrough, a bottom opening 63 for insects to pass therethrough; with the top opening 62 having a top opening inside diameter 62d and the bottom opening having a bottom opening inside diameter 63d. The bottom opening inside diameter 63d is less than the top opening inside diameter 62d. The bottom opening inside diameter 63d is sized to engage the top opening inside diameter 21d of the funnel 20 upon which the collar 60 may be mounted (e.g. funnel 20e in FIG. 12). The funnel collar 60 further comprises multiple slots 64 in the wall 61, spaced from the bottom opening 63 for accepting the tensile connector member 30 therethrough (see FIG. 14). The tensile connector member 30 extends upwards from the multiple tabs 23 of the funnel 20 (upon which the collar 60 is mounted) through the multiple slots 64 of the funnel collar 60 and releasably connects to the multiple tabs 23 of a funnel 20 (or other component of the assembly 10) that is positioned above the funnel collar 60. The tensile connector member 30 may be extended to a desirable length by connecting two or more together for spacing the funnel collar 60 further away from the funnel 20 adjacent to and above.

### Intercept Panels

Having reference to FIGS. 15A-18, alternative embodiments of an insect trap assembly 10 are provided which further comprises a plurality of panels 80 in conjunction with the at least one funnel 20. Those skilled in the art recognize that the panels 80 may be any colour or material a user requires, however, the present embodiment provides for three panels 80 (instead of the traditional 4 panels) for increasing the aerodynamics of the insect trap assembly 10, thereby reducing wind drag when it is positioned for use. In the present embodiment the panels 80 are rectangular in shape but one skilled in the art recognizes that the panels may be any shape. The panels have a top end 81 and a bottom end 82.

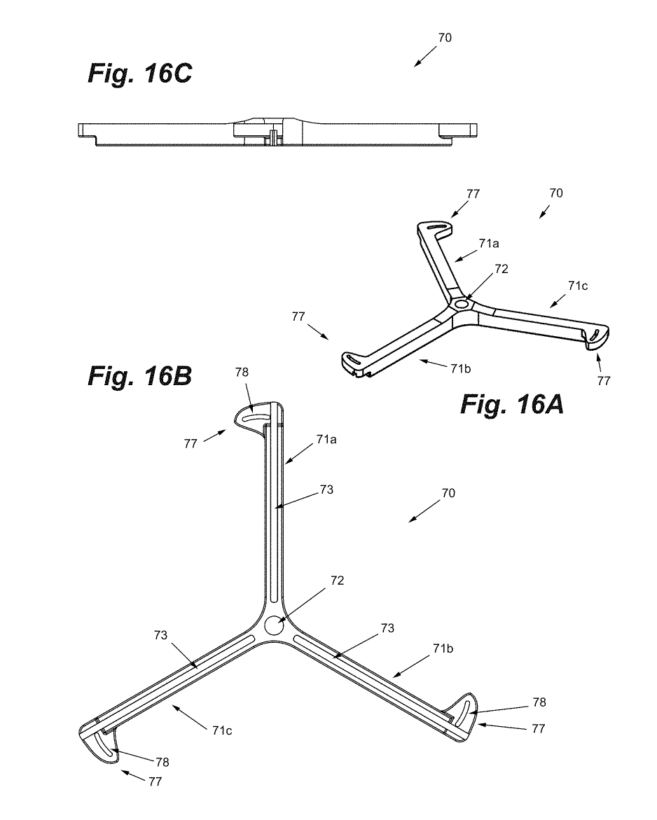

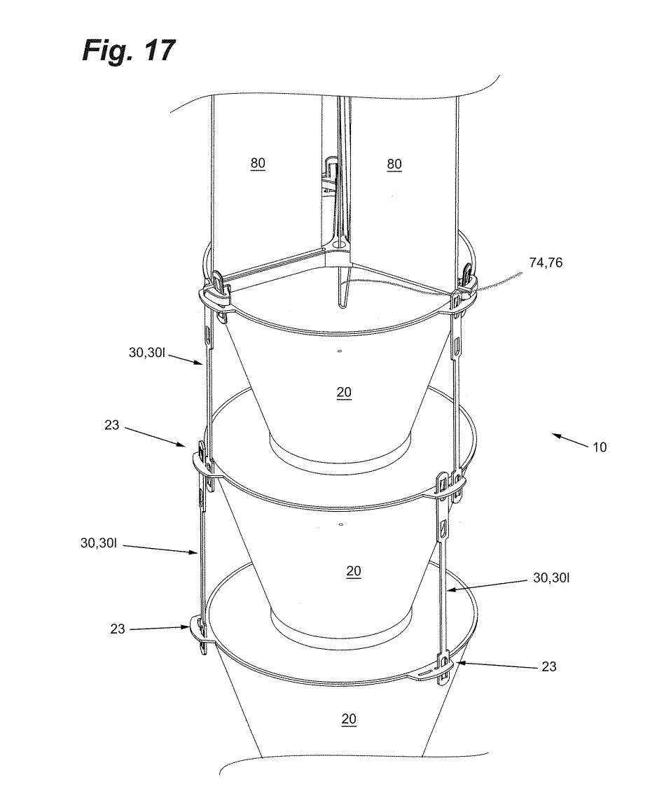

Having reference to FIGS. 16A-17, two spoked panel support members 70 are provided for supporting, mounting and securing the plurality of panels 80 within the trap assembly 10; i.e. a first panel support member 70 for capturing the top ends 81 of each of the three panels 80, and a second panel support member 70 for capturing and supporting the bottom ends 82 of each of the three panels 80—see FIG. 15B).

Each spoked panel support member 70 comprises a central axis having a center aperture 72 therethrough with three arms 71a, 71b, 71c extending axially from the central axis and in a similar plane. The arms 71a, 71b, 71c are preferably positioned equidistant from each other in a plane having an angle of approximately 120° therebetween. At the distal end of the arms 71a, 71b, 71c arm tabs 77 having a slot 78 therethrough are provided for accepting and securing a tensile connector member 30. The panels 80 may be any depth, however, one skilled in the art recognizes that for best results the depth of the panels 80 would be less than or equal to the funnel 20 positioned below. The arms 71a, 71b, 71c of the spoked panel support member 70 further comprises panel slots 73 extending the length of each arm 71a, 71b, 71c. In the present embodiment, the panel slots 73 may be approximately 4 mm wide for accepting an end (81 or 82) of a panel 80. The panel slots 73 accept the bottom end 82 of the panel 80 and is friction fit therein for supporting the panel 80 from the bottom end 81. In another embodiment, the panel 80 may be further secured with the use of a set screw (not shown) which may be inserted from the outer surface of the arms 71a, 71b, 71c and through the panels 80. A second identical spoked panel support member 70 is provided for the top end 81 of the panel 80 to further secure the panel 80 within the insect trap assembly 10. The panel and spoked panel support member assembly may be used in conjunction with the funnel trap system as described above.

In one embodiment, and having reference to FIG. 15A, the panel and spoked panel support member assembly may form the upper portion of the insect trap assembly 10 wherein the canopy 15 is attached to the upper spoked panel support member 70 and the bottom spoked panel support member 70 is releasably connected to the top funnel 20a with the short tensile connector members 30s. A tensile connector member 74 having a first end 75 and a second end 76 is preferably provided. The first end 75 feeds through the center aperture 72 of the bottom spoked panel support member 70 and is secured for preventing the first end 75 from slipping back through the center aperture 72 (see FIG. 17). The tensile connector member 74 may be extended along the longitudinal axis of the assembly 10, toward the top spoked panel support member 70 and through the center aperture 72. The second end 76 of the tensile connector member 74 is then secured to the connection point 16 of the canopy 15, or alternatively fed through the connection opening 16 and the tensile connector member 74 is used directly to hang the insect trap assembly 10 on a stand.

In another embodiment, and having reference to FIG. 18, the panel and spoked panel support members 70 may be incorporated with the funnel collar 60. The funnel collar 60, which may be positioned directly adjacent and below the panel 80. In the present embodiment, larger panel 80 may be used for expanding the insect trap assembly 10 radius. The same spoked panel support member 70 may be used as it is also compatible with larger panels 80.

In operation, target insects may make contact with the one or more the funnels 20 or panels 80 of the assembly 10 and be directed into the collection cup 40. Advantageously, the embodiments provided herein, allow a user to easily customize an insect trap assembly 10 for their specific purpose and to align with various field conditions, including an assembly 10 having both funnels 20 and panels 80.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

What is claimed is:

1. An insect trap assembly comprising:
a collection cup having a circumferential side wall, a bottom and an open flared top, the open flared top having a flared surface and a flared end outside diameter;
at least one funnel for guiding any insects into the collection cup, the at least one funnel having a top opening inside diameter and a bottom opening inside diameter;
wherein the flared end outside diameter is smaller than the funnel's top opening inside diameter, and wherein the flared end outside diameter is greater than the funnel's bottom opening inside diameter, so as to allow the collection cup to be positioned within the funnel in a capture arrangement.

2. An insect trap assembly comprising:
a collection cup;
at least one funnel for guiding any insects into the collection cup; and
a plurality of panels;
wherein the at least one funnel and the plurality of panels cooperate together so as to substantially direct any insects, that may collide with said at least one funnel or plurality of panels, into the collection cup.

3. The insect trap assembly of claim 2 further comprising:
a first spoked panel support member for supporting the top ends of said plurality of panels; and
a second spoked panel support member for supporting the bottom ends of said plurality of panels.
